(19) United States
(12) Patent Application Publication
(10) Pub. No.: US 2003/0102670 A1
(43) Pub. Date: Jun. 5, 2003

(54) Bayonet joint for an annular casing of a high-pressure compressor of a gas turbine

(76) Inventors: Christian Seydel, Stahnsdorf (DE); Uwe Buchholzer, Berlin (DE)

Correspondence Address: The Law Offices of Timothy J. Klima, Suite 330, One Massachusetts Avenue NW, Washington, DC, 20001, US

(21) Appl. No.: 10/309,236

(22) Filed: Dec. 4, 2002

(30) Foreign Application Priority Data
Dec. 5, 2001 (DE) 101 59 669.3

(51) Int. Cl. F16L 35/00

(52) U.S. Cl. 285/361; 285/396; 285/330

(57) ABSTRACT

An annular casing for a high-pressure compressor of a gas turbine includes several casing rings 1, 2 in axial arrangement, with at least two adjacent casing rings 1, 2 being connected by means of a bayonet joint 3.

This application claims priority to German Patent Application DE10159669.3, filed Dec. 5, 2001, the entirety of which is incorporated by reference herein.

### BACKGROUND OF THE INVENTION

This invention relates to a bayonet joint for an annular casing of a high-pressure compressor of a gas turbine.

More specifically, this invention relates to an annular casing, which comprises several casing rings in axial arrangement.

In the state of the art, the annular casing, or its casing rings, are connected by means of axial and/or radial threaded fasteners. The stringent demands on the gap dimensions call for very complex means of connection, which are characterized by a great number of individual components. Accordingly, assembly is very labor and cost-intensive. This applies similarly to any disassembly work required for maintenance or repair. Also, the high number of individual components necessary is undesirable under cost aspects.

In a broad aspect, the present invention provides an annular casing of the type described at the beginning, which combines simple design with easy and cost-effective assembly, while avoiding the disadvantages known from the state of the art.

### BRIEF SUMMARY OF THE INVENTION

It is a particular object of the present invention to provide a solution to the above problems by the apparatus featuring the characteristics described herein, with further objects and advantages of the present invention becoming apparent from the description below.

The present invention accordingly provides for at least two adjacent casing rings being connected by way of a bayonet joint.

The annular casing according to the present invention is characterized by a variety of merits.

One considerable advantage of a bayonet joint for the connection of two adjacent casing rings lies in the fact that assembly is very easy. Such a bayonet joint dispenses with the great number of fasteners (bolts, studs and the like) required for the designs according to the prior art.

Furthermore, a bayonet joint enables sufficiently large forces to be transmitted, providing the casing with adequate stability.

Also, this bayonet joint can be designed such that it is clearance-free in the assembled state.

In one form of the present invention, the casing ring can be composed of individual ring segments.

These ring segments can also be connected by appropriate bayonet joints.

In a preferred embodiment of the present invention, anti-rotation fixation of the bayonet joint, and thus a lock against accidental detachment, is provided by means of separable radial fasteners. These fasteners can be studs, bolts or similar fasteners.

In order to ensure the accuracy of fit of the individual casing parts, it can be favorable to apply at least one marking to at least one casing ring. This ensures that the casing parts (and the stator vane segments attached thereto) are correctly matched for assembly.

It is particularly advantageous if the bayonet joint is provided with sealing surfaces, which face each other and tie with each other. In a preferred embodiment of the present invention, these sealing surfaces can have a trapezoidal or oblique cross-section. Accordingly, the rotational fixation and the tension between the individual parts of the annular casing also create a reliable seal with additional components being dispensable.

It is also particularly favorable if the sealing surfaces are arranged radially outward on the annular casing. Given the form of the bayonet joint, a compact outer contour of the annular casing (inner casing of the high-pressure compressor) can be created enabling cooling-air supplies or the like to be designed more favorably.

### BRIEF DESCRIPTION OF THE DRAWINGS

This invention is more fully described in the light of the accompanying drawings showing a preferred embodiment. In the drawings:

FIG. 1 is a partial sectional view of the annular casing with two casing rings connected by means of a bayonet joint,

FIG. 2 is a perspective simplified view of the forward casing ring with pre-assembled stator vane segments,

FIG. 3 is a sectional view, similar to FIG. 1, in modified sectional representation, and

FIG. 4 is a partial side view of the outer contour of the annular casing according to the present invention.

### DETAILED DESCRIPTION OF THE INVENTION

The Figures of the embodiment represent only a partial area of the annular casing according to the present invention, with the representation of further details being dispensed with.

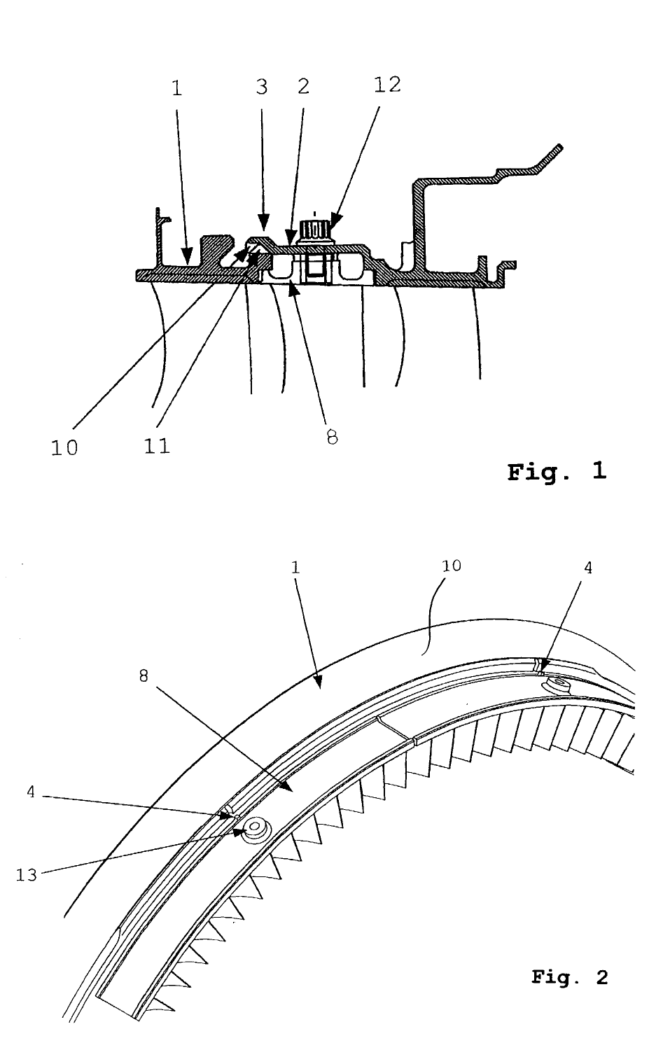

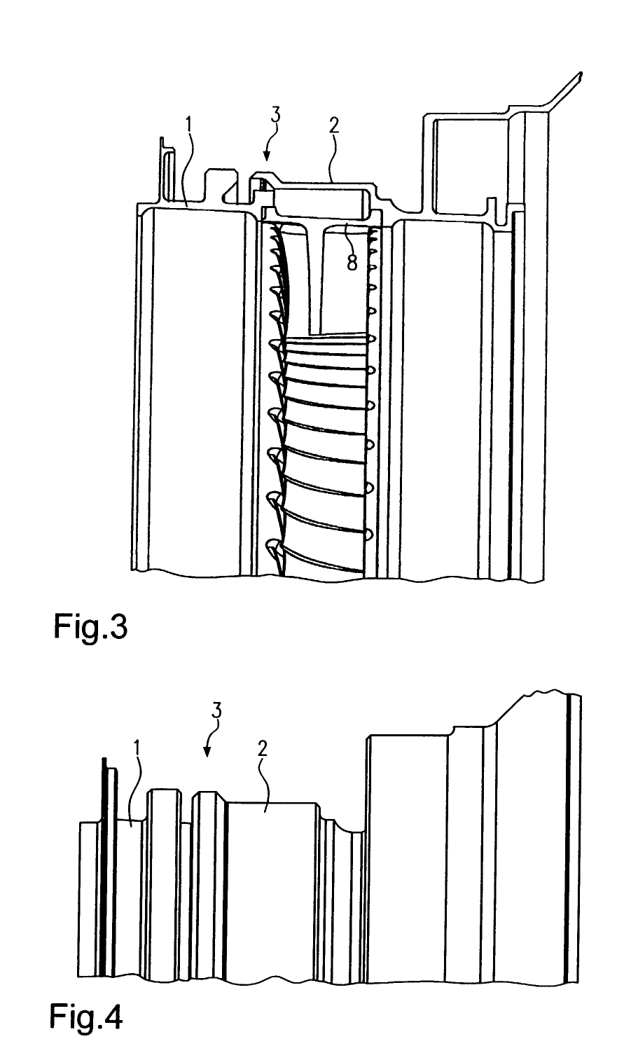

The figures show a forward casing ring 1 and a rearward casing ring 2. These are connected by means of a bayonet joint 3. As becomes apparent in particular from FIG. 1, the bayonet joint 3 comprises trapezoidal elements 10, 11 which engage with each other and have oblique mating surfaces each. Although the trapezoidal elements 10 and 11 need not continuously encircle the respective circumferences of the casing rings 1 and 2, in a preferred embodiment, portions of the elements 10 and 11 that engage each other do continuously encircle the respective circumferences of the casing rings 1 and 2 to provide a tight seal between the casing rings 1 and 2 when they are connected together.

The two casing rings are fitted together by means of the bayonet joints and twisted relative to each other by a given angle. Rotational fixation and lock is achieved by a plurality of fasteners 12, these fasteners also exerting a radial force and closely tieing the trapezoidal elements 10, 11 with each other.

As becomes apparent from the Figures, the outer contour (see FIG. 4) has a relatively smooth surface, this facilitating the supply of cooling air and the incorporation of cooling-air openings or similar.

As becomes apparent from FIG. 1, several stator vane segments 8, together forming another casing ring, are attached to the inner area of the rearward casing ring 2 by means of fasteners 12. For this purpose, the stator vane segments are equipped with threaded inserts 13 into which studs or bolts can be installed, as shown in FIG. 1. In order to facilitate the pre-assembly of the stator vane segments 8, rigging elements 4 (lugs and grooves) are provided on the forward casing ring 1 and on the stator vane segments 8 which pre-locate and prevent accidental rotation of the parts.

Summarizing, then, the bayonet joint, which is made by the trapezoidal elements 10, 11, ensures adequate fixation, good transmission of force and excellent sealing.

It is apparent that a plurality of modifications may be made to the embodiment here shown without departing from the inventive concept and that various aspects of the present invention can be combined in different combinations to create different embodiments.

What is claimed is:

1. An annular casing for a high-pressure compressor of a gas turbine, comprising:
a plurality of casing rings in axial arrangement, and
at least one bayonet joint connecting two of the casing rings to one another.

2. An annular casing in accordance with claim 1, wherein at least one casing ring is made up of a plurality of stator ring segments.

3. An annular casing in accordance with claim 2, and further comprising at least one separable radial fastener engaging at least one of the two connected casing rings to provide an anti-rotation lock between the two connected casing rings.

4. An annular casing in accordance with claim 3, and further comprising at least one marking on at least one of the casing rings to locate one of the components of the annular casing.

5. An annular casing in accordance with claim 4, wherein the bayonet joint includes sealing surfaces which face each other and which tie with each other.

6. An annular casing in accordance with claim 5, wherein the sealing surfaces have a trapezoidal cross-section.

7. An annular casing in accordance with claim 6, wherein the sealing surfaces are arranged radially outward on the annular casing.

8. An annular casing in accordance with claim 1, and further comprising at least one separable radial fastener engaging at least one of the two connected casing rings to provide an anti-rotation lock between the two connected casing rings.

9. An annular casing in accordance with claim 8, and further comprising a plurality of separable radial fasteners engaging at least one of the two connected casing rings to provide an anti-rotation lock between the two connected casing rings.

10. An annular casing in accordance with claim 9, wherein the bayonet joint includes sealing surfaces which face each other and which tie with each other.

11. An annular casing in accordance with claim 10, wherein the sealing surfaces have a trapezoidal cross-section.

12. An annular casing in accordance with claim 11, wherein the sealing surfaces are arranged radially outward on the annular casing.

13. An annular casing in accordance with claim 1, and further comprising at least one marking on at least one of the casing rings to locate one of the components of the annular casing.

14. An annular casing in accordance with claim 1, wherein the bayonet joint includes sealing surfaces which face each other and which tie with each other.

15. An annular casing in accordance with claim 14, wherein the sealing surfaces have a trapezoidal cross-section.

16. An annular casing in accordance with claim 15, wherein the sealing surfaces are arranged radially outward on the annular casing.

17. An annular casing in accordance with claim 14, wherein the sealing surfaces are arranged radially outward on the annular casing.
